(19) United States
(12) Patent Application Publication
(10) Pub. No.: US 2019/0061880 A1
(43) Pub. Date: Feb. 28, 2019

(54) Flying Craft with Realtime Controlled Hydrofoil

(71) Applicant: Gabriel Bousquet, San Mateo, CA (US)

(72) Inventor: Gabriel Bousquet, San Mateo, CA (US)

(21) Appl. No.: 16/081,207

(22) PCT Filed: Apr. 21, 2017
(86) PCT No.: PCT/US17/28840

§ 371 Date: Aug. 30, 2018

Related U.S. Application Data
(60) Provisional application No. 62/325,753, filed on Apr. 21, 2016.

(51) Int. Cl. B63B 1/28; B60F 5/00; B63B 1/24; B63H 9/06; B64C 35/00

(52) U.S. Cl. CPC B63B 1/285; B60F 5/00; B63B 1/242; B63J 99/00; B63H 9/0607; B64C 35/007; B63B 1/283

(57) ABSTRACT

This disclosure describes a vehicle configured and arranged to generate lift and drag using a plurality of lifting or control surfaces including a water-piercing hydrofoil disposed below said vehicle, and a method for real-time control of said lifting or control surfaces by controlling at least the hydrofoil with an actuator that is actuated responsive to measured input signals including forces on said hydrofoil.

### CROSS-REFERENCE TO RELATED APPLICATIONS

This application claims the benefit of and priority to U.S. Provisional Application No. 62/325,753, titled “The Amphibious Glider: a Biologically Inspired, Extra Long Range Platform for Ocean Monitoring,” filed on Apr. 21, 2016, which is hereby incorporated by reference.

### TECHNICAL FIELD

The present application relates generally to the design and control of vehicles, including craft having lifting or control surfaces for generating lift, and specifically flying and sailing craft where the craft's dynamics are affected by both airborne lifting surfaces and hydrofoil design and operation.

### BACKGROUND

Vehicles that travel over land and water include aircraft, which have airborne lifting control surfaces, commonly referred to as wings, generating upward lift to counter the downward force of gravity acting on the aircraft, and other lifting surfaces as needed to steer and stabilize the aircraft. Ships, boats and other watercraft, especially sail boats, are known to generate fluid dynamic forces with their lifting surfaces to propel these craft from one location to another on the surface of a body of water. In general, the operation of wind-propelled systems relies on three functions: one function counters the force of gravity, such as the buoyancy of the hull of a sailboat, another function slows down the wind, providing a generally down-wind and forward force such as provided by the sail of a sailboat, and yet another function generates a balancing upwind force by applying force on a slow medium, such as the keel of a sailboat in water. In some prior systems with a hydrofoil in water, the hydrofoil may not always be structurally able to withstand the forces it could otherwise generate under certain travel conditions.

Some craft designs have been proposed to travel on or above the surface of water using a plurality of airborne and waterborne lifting or control surfaces. It is unclear whether all such designs are practical, safe, economical, efficient or even feasible. Existing systems have difficulties to contact and leave the water surface repeatedly especially if the water surface is not extremely flat. For instance, hydrofoil boats fail when their hydrofoil leaves the water as reentry is often a catastrophic event (due to the large forces at play, and their complicated and unsteady nature due to surface effect and transient ventilation and cavitation), and hydroplanes can only land on sheltered waters.

U.S. Pat. No. 3,800,724 is directed to a winged sailing craft having two elongated and equivalent aerial wings (one vertical and the other horizontal) as well as a water-piercing hydrofoil disposed vertically beneath said sailing craft to generate upwind force. U.S. Pat. No. 6,341,571 is directed to a wind-powered air/water interface craft having pivoting wings with various angles and configurations, including a combination of aerial dihedral wings and a water-piercing hydrofoil arranged in a triangular configuration with respect to one another. And U.S. Pat. No. 6,032,603 is directed to a method and apparatus to purportedly increase the velocity of sailing vessels, incorporating aerial sails above water and below-water (water-piercing) lift and keel rudder elements. Each of the foregoing references, given by way of example, are hereby incorporated by reference.

One problem the present system and method can address is that of dynamic stability and robustness. Some prior art designs of flying sailboats rely on concept wings that purportedly act as sails and vice-versa when tacking between starboard and port. The dihedral arrangement of such wings makes them sensitive in roll to wind gusts. Other prior attempts to make flying sailboats suffer from over complex mechanical designs such as hinged wings, costly or unwieldy form factors, and other challenges such as floats and hydrofoils at the wing tips which are potentially the source of unacceptable yawing moments. As another example of prior art challenges, external forces such as pitching forces and frictional forces on a craft would cause the craft to stumble catastrophically if the craft encounters external drag forces causing it to develop excessive moments about some axis.

The above-mentioned and similar references purport to solve certain problems and offer certain advantages. However, the state of the art solutions are generally impractical, unstable, and are less than ideal for many applications.

### SUMMARY

One embodiment is directed to vehicle for travel over an air-water interface, comprising a vehicle body; said vehicle including a position-sensing system indicating a position or travel speed of said vehicle; said vehicle being overall positively buoyant with respect to said water; a lower portion of said vehicle being configured and arranged for movement through at least said water and an upper portion of said vehicle being configured and arranged for movement through at least said air; at least one aerial lifting or control surface, coupled to said vehicle body, and configured and arranged for providing aerodynamic lift; at least one hydrofoil, coupled to said vehicle body, and configured and arranged for providing a hydrodynamic load; an elevation-sensor indicating an elevation of a reference point on said hydrofoil with respect to said air-water interface; at least one force sensor coupled to said hydrofoil and providing a measured output signal indicative of said hydrodynamic load; the vehicle further comprising a processor receiving inputs representative of: the position or travel speed of the vehicle, the measured output of said force sensor, and the elevation of said reference point; the processor comprising processing circuitry for processing data and executing machine-readable instructions including control logic, and for providing, responsive to any of said inputs, an output control signal; and an actuator receiving said output control signal and mechanically controlling at least said hydrofoil responsive to said output control signal.

Another embodiment is directed to a method for controlling the travel of a vehicle proximal to an active water surface, comprising measuring a location or speed of said vehicle; measuring an elevation of a reference point on said vehicle above said water surface; measuring with measured input signals: a hydrodynamic load on a vertical hydrofoil of said vehicle, extending at least partially below said water surface, while said vehicle is traveling; generating a control output signal based on at least said measured input signals; and applying a torque on said hydrofoil, about at least one degree of freedom thereof, responsive to the control output signal.

### IN THE DRAWINGS

For a fuller understanding of the nature and advantages of the present invention, reference is made to the following detailed description of preferred embodiments and in connection with the accompanying drawings, in which:

FIG. 1A is a perspective view of a flying craft with an aerial sail and a controllable water-piercing hydrofoil;

FIG. 1B is a top view of a flying craft with an aerial sail and a controllable water-piercing hydrofoil;

FIG. 1C is a (port) side view of a flying craft with an aerial sail and a controllable water-piercing hydrofoil;

FIG. 2 illustrates controllable rotation of a hydrofoil using an actuator;

FIG. 3 illustrates a water-piercing hydrofoil with force sensors;

FIG. 4A illustrates side and front views of a water-piercing hydrofoil with associated forces and displacements;

FIG. 4B illustrates a top view of the hydrofoil of the preceding figure;

FIG. 5 illustrates a mode of operation of a flying craft with an aerial sail and controllable hydrofoil;

FIG. 6 illustrates another mode of operation of a flying craft with an aerial sail and controllable hydrofoil;

FIG. 7 illustrates a method for operating and controlling a flying craft with a controllable hydrofoil;

FIG. 8A is a perspective view of an exemplary flying craft with a controllable water-piercing hydrofoil;

FIG. 8B is a (port) side view of a flying craft with a controllable water-piercing hydrofoil;

FIG. 9A illustrates a top view of a mode of operation of a flying craft with a controllable water-piercing controllable hydrofoil; and

FIG. 9B illustrates a side view of the sequence of FIG. 9A.

### DETAILED DESCRIPTION

An object of this invention is to provide useful vehicle systems and methods for operating and controlling such vehicles or craft. The present craft are at least sometimes operated proximal to an interface of two fluids. In the most general case, embodiments hereof can operate at or near an interface separating two fluids of different densities, including two liquids, a liquid and a gas, or two gases. In a preferred embodiment, the present invention can be operated at an air-water interface such as would be found at the surface of an ocean, lake, river or other natural or man-made body of water. By design, the present systems and methods can provide a craft body and a plurality of foils or lifting or control surfaces coupled, rigidly and/or moveably, to said craft body. In an embodiment, at least one aerial lifting or control surface or wing of the craft is disposed so as to move through the air above the air-water interface, while at least one hydrofoil of the craft is disposed so as to move through the water below the air-water interface.

Generally, the present system and method can provide a vessel, vehicle or craft that can travel substantially in the air, at, or near and above the surface of water. The craft may have both airborne and water-piercing control surfaces to provide needed lift, drag or other forces to stabilize and/or drive the craft. Other modes of operation of the present craft are also possible, as will be described below and understood by those of skill in the art.

The present craft is adaptable for operation with an external and/or internal propulsion system. For example, the craft may be towed or co-propelled with another vessel, e.g., in side-car mode. In another example, the craft may use an onboard electric, gasoline, solar or other propulsion mechanism, i.e., pushing itself through the air and/or water.

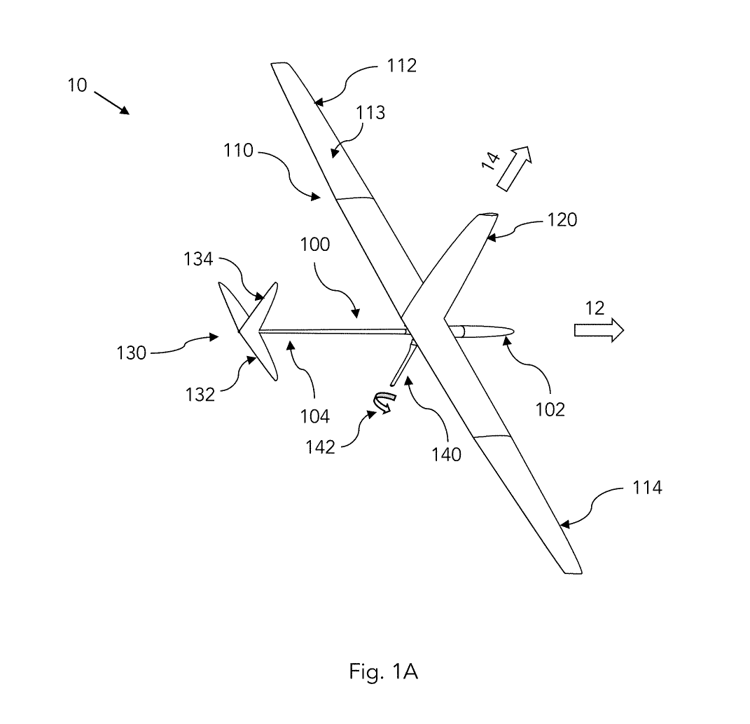

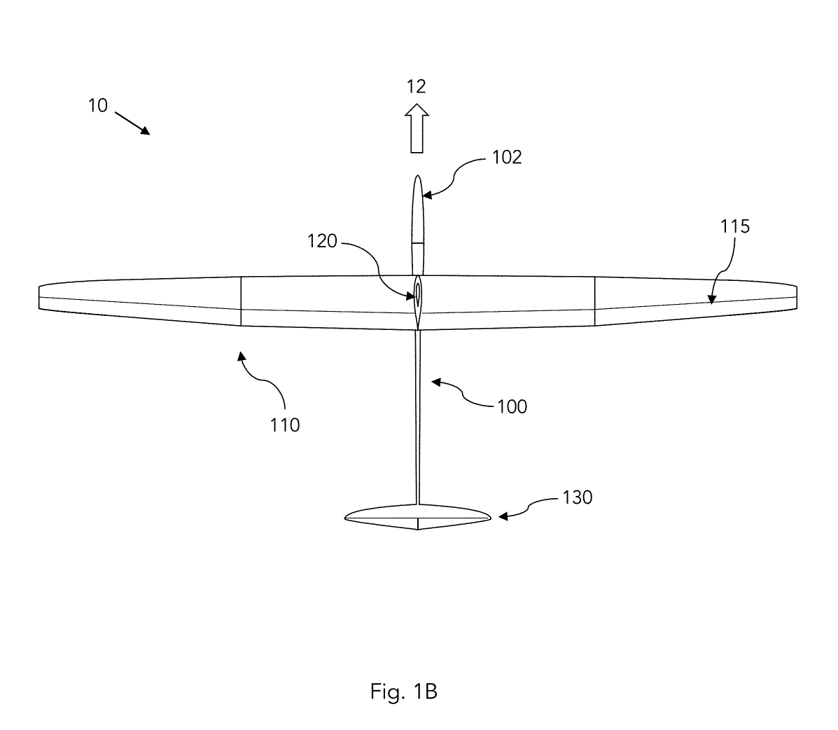

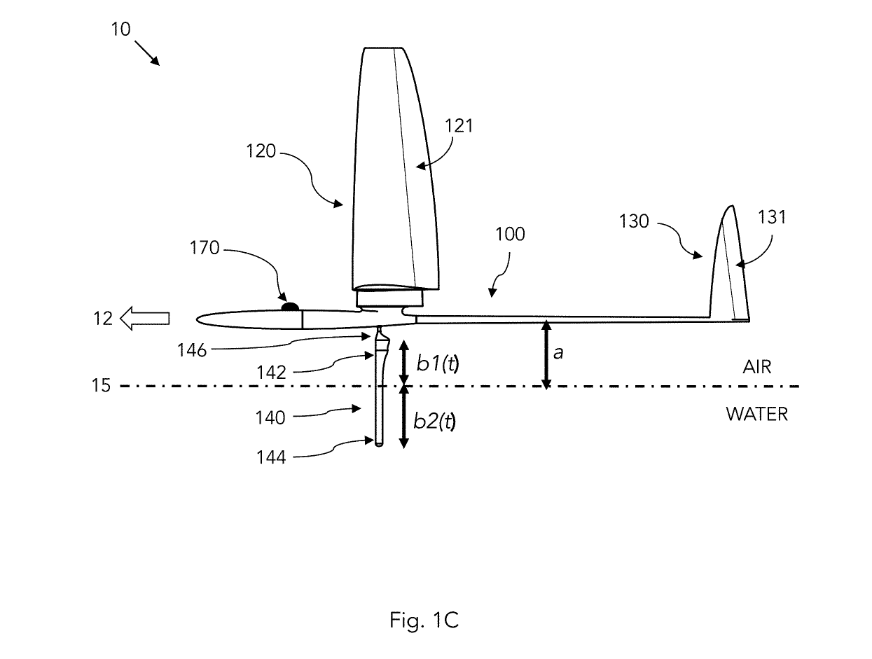

FIG. 1A illustrates a vehicle, vessel or craft 10, and in particular a perspective view of said craft 10, according to an embodiment hereof. Craft 10 comprises a vehicle or craft body 100, which may be constructed, dimensioned and arranged according to any reasonable form, for example to carry persons, a payload, or test equipment, or to conform to any desired application. Craft body 100 is elongated for aerodynamic performance and has a forward or nose section near its front and an aft section 104 near its tail 130. Some embodiments hereof may further incorporate canard control surfaces, V-shaped tails, or other elements as suits a given application.

The materials of construction of body 100 may be of appropriate solid materials providing rigidity and structural integrity, yet preferably light in weight so as to allow for practical flight of the craft 10 without undue structural load. For example, body 100 may be formed from a polymer resin, fiberglass, carbon fiber, composite, wood, thin shell aluminum panels, or other suitable sheet, cast or molded material. In some embodiments, craft 10 is configured and designed as a small craft for scientific observation, measurement and similar test purposes, and may be dimensioned to have a length and/or span on the order of one meter (1 m). However, this disclosure and invention are not so limited, and can scale as needed for other applications, the scaling of such vessels being a subject known to those skilled in the art. The craft 10 is designed to travel in a forward direction 12, generally along a long axis of body 100 as show by the arrow in FIG. 1A.

Mechanically coupled to body 100 is a wing structure 110, which in the shown embodiment comprises a port section 112 and a starboard section 114 that may be formed as a single structure or as separate structures, as would be appreciated by those skilled in the arts of aircraft design. The wing 110 is designed to provide aerodynamic lift perpendicular to a direction of air flow over said control surface, or generally perpendicular to an upper face 113 of wing 110. The lift can be quantified by the dimensions, including the chord distribution, span and profile or cross-sectional geometry of wing 110 as known to those skilled in the art of aircraft design. The wing 110 may be fixed in some specific embodiments, but wing 110 may also be mechanically articulated about one or more degrees of freedom in other embodiments, or wing 110 may have one or more ailerons that are mechanically positionable according to a need so as to modify the provided lift of wing 110. As with body 100, wing 110 may be constructed and arranged according to methods and designs known to those skilled in the art, and may be constructed of a same or different material as body 100 (e.g., using the materials mentioned above by way of example).

Tail section 130 is coupled to body 100 as would be appreciated by those skilled in the art of aircraft design. Tail section 130 may comprise one part or may comprise several parts, for example having both horizontal planes 132 and one or more vertical tail section sails 134, each providing lift in the respective dimension depending on its orientation. Also, a tail member having a V-shaped configuration may be used in other examples.

In the shown embodiment, a vertical aerial control member or sail 120 is coupled to body 100, the sail 120 extending from its coupling point upwardly along the upward direction 14 as shown in FIG. 1, where the upward direction 14 is perpendicular to the forward direction 12 of craft 10. The sail 120 may be actuated about a generally vertical axis, of lift controllable by means of flaps, or it may be fixed in which case the sail lift may be controlled by yawing the craft's body.

In addition, craft 10 is equipped with an elongated downwardly-pointing hydrofoil 140, which is mechanically coupled to craft body 100 and which defined a span, cord distribution and cross-sectional foil profile to be discussed in more detail below. Hydrofoil 140 is designed to penetrate the air-water surface above which craft 10 travels so that at least a (distal or lower) portion of the span of hydrofoil 140 is beneath the air-water interface during flight of craft 10, while some (proximal or upper) portion of the span is in air above the air-water interface. As would be appreciated, when craft 10 is traveling forward along general direction 12, the actuation of any of its control surfaces, wings, foils, etc., such as hydrofoil 140 would cause a corresponding interaction with the respective surrounding fluid (e.g., air, water) and cause a corresponding fluid dynamic force or moment.

Hydrofoil 140 is configured and arranged to be mechanically actuated by an actuator that provides rotation of hydrofoil 140 about a long axis thereof as illustrated by rotation arrow 142. As will be described in more detail below, the actuation, rotation, or turning of hydrofoil 140 can be used to controllably stabilize the movement of craft 10 under load (during flight) including by controlling lift and drag forces generated by hydrofoil 140, especially using the distal (lower) portion of hydrofoil 140 that is submerged beneath the surface of an air-water interface.

FIG. 1C is a side view of craft 10 in one example embodiment. We see that the control members (e.g., sails, wings, foils) can extend upwardly or downwardly from the body 100 of craft 10. These control members, or portions thereof, can be controllable using actuators to mechanically position the members or the controllable portions. For example, vertical sail 120 may be rotatable about its vertical axis, in its entirety, and/or it may be modified by adjustment of an aileron 121 at the trailing edge of sail 120. The same can be said for vertical tail member and aileron 131. The figure also shows a global positioning system (GPS) antenna or sensor or communicator 170. As will be described in more detail below, GPS sensor 170 is used to obtain real-time absolute position and/or speed data for craft 10, which are used in some embodiments as input data to a processor used to control the flight of craft 10.

It should be appreciated that the present concepts may be applied to other fluid media than air and water, whether in an artificial environment or naturally occurring. For example, any gas may be substituted for the examples of air herein, and any liquid may be substituted for the examples of water herein, so long as these fluid media and interfaces support a given application of interest and are consistent with the present engineering and physical principles.

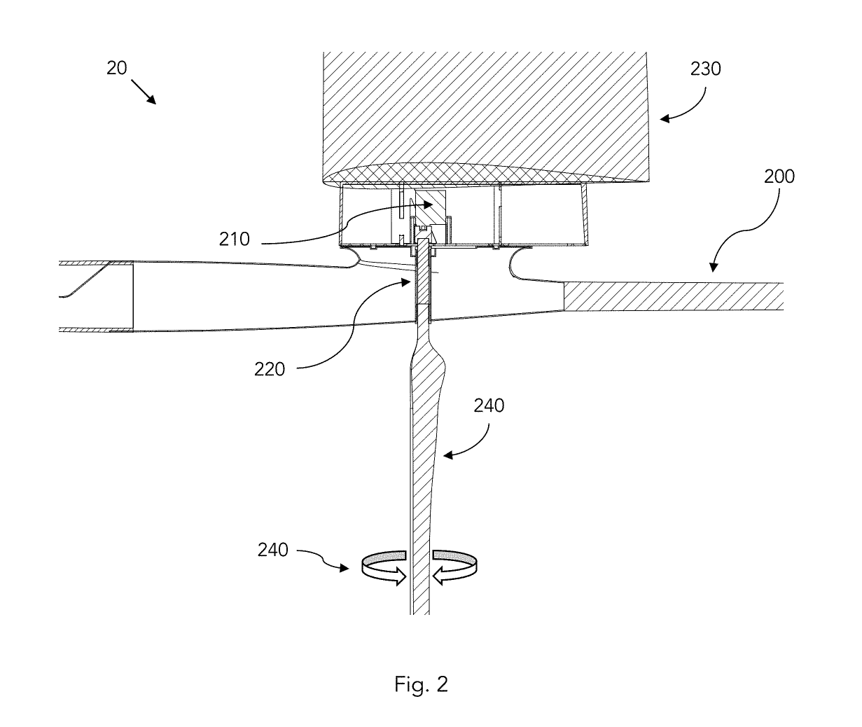

FIG. 2 illustrates a top view of craft 10, where craft body 100 is in this example an elongated aerodynamic body designed for forward travel in a direction 12 generally in-line with a long axis of said body. The top view of vertical sail 120 illustrates that said sail 120 has an aerodynamic foil profile as suitable for a given application and to provide aerodynamic lift and/or drag to craft 10. In some embodiments, one or more of: wings 110, vertical sail 120 and/or tail section(s) 130 may include controllable flaps, spoilers, ailerons, or similar control surfaces 115, or fully moveable pitch actuation for added control of an aerodynamic force provided thereby. For the sake of generality, such fluid dynamic surfaces are referred to as “lifting surfaces”, “control surfaces” or “control members” herein. Semantically speaking, it should be noted that the pitch as well as the angle of attack of a hydrofoil, sail or other vertically-disposed control surface may be about an axis of said member (e.g., about a vertical axis) whereas the overall pitch or angle of attack of the craft itself may be about another axis if the craft pitches during travel.

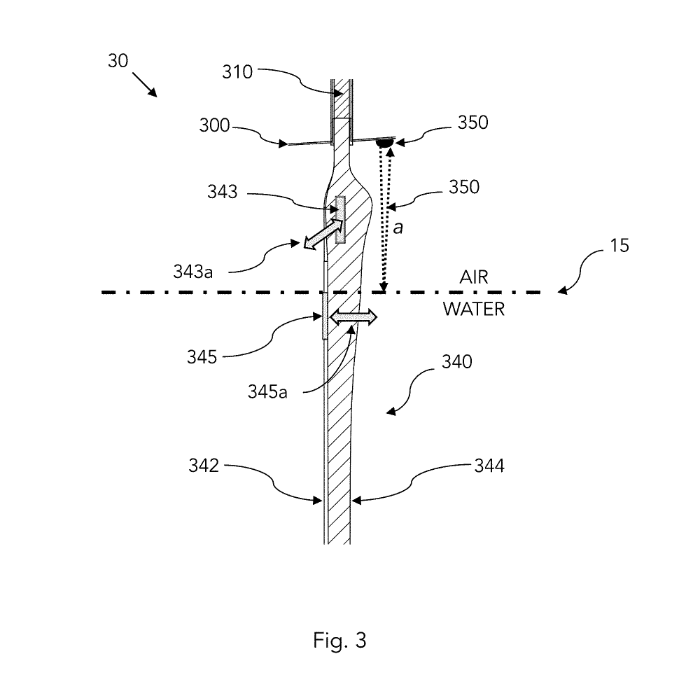

FIG. 3 illustrates a (port) side view of craft 10, which is designed and operated to travel to the left, generally along the long axis 12 of craft body 100. As described earlier, craft body 100 is mechanically coupled to several wings, sails, foils or other fluid dynamic surfaces. Here, a vertical sail 120 is provided generally at a midsection of said body 100, a tail section 130 is affixed to body 100 at an aft end thereof. One or more (e.g., a horizontal and/or vertical) sections of sail 120 and/or tail control surface(s) 130 may comprise mechanically-hinged ailerons 121, 131 or sub-sections that are usable to assist in the craft's dynamics. For example, the ailerons 121, 131 may be actuated by manually or computer-controlled means by way of electromechanical drives, servos, or hydraulic actuators.

A downward-extending vertical hydrofoil 140 is mechanically coupled to body 100, in an embodiment, at or near a midsection of body 100 as shown. Hydrofoil 140 is generally an elongated fluid dynamic member, foil, blade, wing or similar member. Hydrofoil 140 has a first (upper, proximal) end 142 closest to craft body 100, and an opposing second (lower, distal, or terminal) end or tip 144 furthest from craft body 100.

In typical operation, craft 10 is operated in a flying mode at or proximal to and above an air-water interface 15. Depending on the prevailing conditions, air-water interface 15 may be calm (having a generally linear cross-section as shown), or it may be wavy due to the presence of surface waves, for instance wind-driven gravity waves, on the surface of a body of water such as an open sea. In any case, craft 10 flies forward along direction 12, generally parallel to an undisturbed (or average) surface of such body of water. The actual dimensions of craft 10, its speed of travel and its altitude (a) above the surface 15 are all design matters and can depend on the desired operational characteristics of craft 10, prevailing physical conditions, and other factors. As will be discussed below, craft 10 is dynamically stable during flight, and for at least some periods of time, sustains a lower (distal) portion of its hydrofoil 140 in the lower fluid medium (here, and typically, water) as shown. Again, downward-extending hydrofoil 140 may be fixed with respect to the craft body, or it may be moveable in its entirety (e.g., rotating about an axis), and/or it may be equipped with ailerons or sub-sections that are moveable or separately articulated, especially at its trailing (aft) edge, which may be used for fine-tuning the forces provided by said hydrofoil during use.

If craft 10 is in steady state motion, the mean lift and drag and gravitational and buoyancy forces thereon can lead to steady movement of craft 10 in the forward direction 12, generally cross-wind (e.g., at 90 degrees to the wind with up to a 45 degree or more variation thereabout) with little or no lateral (side-to-side) or vertical (up-and-down) movement, as well as little or no roll, pitch or yaw. For instance, roll can be set to zero by trimming the ailerons to compensate any roll moment generated by the hydrofoil or other lifting surfaces. In practical situations, as has been tested in open water bodies by the inventor, external time-varying forces act on craft 10 so as to disturb craft 10 somewhat from its nominal flight path. Primary examples are non-uniform water currents, eddies, turbulence and surface waves that affect craft 10 through the resulting unsteady hydrodynamic and aerodynamic forces of said water acting on the submerged portion of hydrofoil 140 and aerial control surfaces. It should be noted that the depth of immersion of hydrofoil 140 will typically be time-varying, which exposes varying surface area of hydrofoil 140 to the prevailing water forces thereon. That is, during times that craft 10 rises higher above the air-water interface 15 (i.e., elevation distance, a, increases) the surface area of hydrofoil 140 lower, submerged portion of hydrofoil 140 exposed to water forces decreases, and hydrofoil 140 may even entirely rise above the water if the elevation distance, a, exceeds the length of the hydrofoil. The opposite occurs when craft 10 drops lower (i.e., elevation distance, a, decreases), as more of hydrofoil 140 dips into the water below surface 15, resulting in greater surface area of the hydrofoil exposed to the forces of water.

If the overall span (active length in the elongated direction) of the hydrofoil 140 is b, we may consider its upper portion operating outside of (above) surface 15 at a given time t to b1(t) and its submerged (lower) portion operating below the surface 15 to be b2(t) where b=b1(t)+b2(t). In some embodiments, b1(t) may be equal to the reference height or flight altitude, a, of said craft. In some of the present mathematical discussion, the length of the immersed hydrofoil section may be referred to as “h”.

FIG. 2 illustrates a more detailed exemplary cross-section of the portion of a craft 20 including a vertical sail 230 extending upwardly from craft body 200 and a hydrofoil 240 extending downwardly from craft body 200.

A computer-controlled actuator, or plurality of actuators 210 are used to control the one or more control surfaces of craft 20. In an example, a plurality of sensors and environmental inputs deliver input signals to a processor or computer on board said craft 20. The processor or computer then uses said inputs, and stored machine-readable instructions, models, programs, data or other information to collectively generate output control signals for controlling one or more craft control surfaces. For example, actuator 210 may include an electro-mechanical actuator, servo, or similar apparatus 210. The actuator 210 is mechanically coupled to a coupling (e.g., gears, reduction mechanism, or direct drives) 220 controlling an angular rotation 230 of shaft 220. More generally, direct or indirect pitch control may be employed and/or compliance or damping control may be used for the same or equivalent result. In addition, the system may control the equilibrium (rotation) angle of the hydroplane coupling shaft. In yet another aspect, a trailing edge flap or aileron can be used to set the equilibrium angle of attack of the hydrofoil's coupling shaft.

The present inventor has determined and tested a craft such as the one illustrated in the foregoing figures and has confirmed that with suitable real-time control of the craft's control surfaces, especially hydrofoil 140, the craft can be successfully operated and be stabilized under real conditions, including in the presence of surface waves that cause the elevation distance, a, to increase and decrease.

In one embodiment, but not limiting of the present invention, one or both of vertical sail 120, 220 and/or hydrofoil 140, 240 may be disposed at or proximal to a center of gravity of craft 10, 20 or craft body 100, 200.

We now discuss some aspects of the dynamic operation of the present craft. Those skilled in the art would be able to take the present disclosure and generalize it or apply it to specific designs and modes of operation as desired.

In one aspect, the present system and method is controlled by a processor or computer that accepts a manageable number of inputs from sensors so as to generate real-time output control signals. Prior systems and methods lacked the present sensors, processors, outputs and actuators configured and adapted for a craft of suitable design. The present disclosure offers some non-limiting examples illustrating the operation of the present system.

Hydrofoils generally may operate in fully wetted condition, or in partially or fully ventilated or cavitating condition or a combination thereof. Ventilation is the phenomenon where air in entrained to the region of low pressure on e.g. the suction side of a hydrofoil and forms a cavity. Ventilation is enabled by cavitation, flow separation and or connection of the trailing edge vortex to the free surface. Cavitation is when the local pressure on the suction face of the hydrofoil falls below the pressure of water vaporization. Like ventilation, cavitation is associated with a severe loss of lift and increase of drag. As a rule of thumb, cavitation starts being a possibility for high lift surfaces near 20 kts and is very likely to be present on most airfoils above 50 kts. Ventilation and cavitation are favored at large lift coefficients. As a rule of thumb, hydrofoils designed for fully wetted flows don't perform well when ventilation or cavitation occurs, and conversely, hydrofoils designed for cavitating or ventilated flows relatively don't perform well in fully wetted flows.

In an aspect, the present system and method can overcome the adverse effects of cavitation and/or ventilation, which can occur under certain fluid dynamic conditions. The hydrofoils may be designed to operate at small lift coefficients. With careful airfoil selection and hydrofoil control as explained below, cavitation is unlikely to appear until at least 30 kts and ventilation may be avoided. On hydrofoils designed for non-ventilating flows, ventilation induces a loss of lift as well as a significant increase in drag, which might be sufficient to create a significant pitch down moment onto the airplane, which can lead to the failure of the flight process if not properly controlled or avoided. The small lift coefficients of the hydrofoil in the present application are not favorable to ventilation inception. The present system and method are designed to detect and/or avoid these effects in the first place prior to failure of the traveling craft takes place.

In another aspect, the foil may be designed to induce ventilation or cavitation (rather than a rounded nose airfoil profile, it could for instance be a wedge profile, as one skilled in the field would know.). In this instance, non-ventilating/cavitating flow is an undesired mode of operation and can be detected and avoided with the sensors discussed in this disclosure.

FIG. 3 illustrates an exemplary hydrofoil 340 according to one or more embodiments hereof, coupled to a craft body 300, and extending downwardly therefrom. Hydrofoil 340 includes a forward-facing leading edge 342 and a rear-facing or trailing edge 344. Hydrofoil 340 may be further actuated and rotated about its long axis at shaft 310, e.g., using a servo as described above. We discussed measuring and taking inputs for real-time control of the present system. In an aspect, one or more strain gauges, force sensors/meters, accelerometers, or displacement gauges 343, 345 (generally “force gauges”) are provided on hydrofoil 340, or to a shaft or coupling connecting the hydrofoil 340 to the rest of the craft. The aim being that the hydrodynamic forces and moments on the hydrofoil can be measured. The force gauges 343, 345 are used to measure forces on hydrofoil 340. Specifically, force gauge 343 may be used to measure a sideways force or moment 343a in a direction or about an axis corresponding to a sensitivity of force gauge 343 (for example, along a direction normal to the main surfaces of the hydrofoil). In a particular, but not limiting example, force gauge 343 comprises one or more strain gauges measuring a strain resulting from deflection of hydrofoil 340 during its travel as a portion of the hydrofoil is submerged in a liquid (e.g., water) and subject to the forces exerted by the water on the surface of hydrofoil 340. Those skilled in the art will understand that additional force gauges, such as strain gauges or others as mentioned above, can be used to measure strains or forces or moments about other directions. For illustrative purposes, FIG. 3 shows a second force gauge 345 disposed on hydrofoil 340 and measuring a second force or moment 345a (for example, in a fore-to-aft direction). In a basic embodiment demonstrated by the inventor, a single strain gauge 343 was used to generate an electrical signal corresponding to a force or moment 343a on hydrofoil 340. This signal was input, with other input signals and parameters, to a processor, which was used in turn to actively control the pitch (or angle of rotation) of shaft 310 by way of an electro-mechanical servo.

In an aspect, a height or distance sensor 350 is disposed at a practical location on craft 30. For example, an ultrasonic time-of-flight (echo or sonar) device 350 is mounted to an under-body portion of craft body 300, e.g., below a wing or fuselage thereof. The height sensor 350 measures the distance between a reference point on craft 30 and the surface of the water below 15. The surface 15 may be calm (undisturbed) or may be wavy (disturbed) as will be discussed below, which leads to varying depths of insertion of hydrofoil 340 into the water under craft 30, and subsequently to varying forces of lift and drag corresponding to the state of submersion of the hydrofoil 340. Other embodiments of a height sensor may be used as well, for example optical cameras, lasers, conductivity meters, capacitance meters, etc. The reference measurements indicating the depth of insertion of hydrofoil 340 into the water at a given moment may be repeated rapidly (for example at 1 Hz, 10 Hz, 100 Hz or another rate as called for).

An exemplary system was set up by the inventor to stabilize a flying sailboat or air-water craft about one meter long and having a wing span on the order of one meter, e.g., about 3 meters, such as those described above, which was flown at a height (a) of several centimeters above the surface of a natural river at speeds on the order of 10 meters/sec. Those skilled in the art will appreciate how such a system can be scaled upwards or downwards in size, speed or other parameters using non-dimensional fluid dynamic analysis or other theoretical, empirical, or numerical techniques. In addition, the present system and method can utilize and include such force sensors on any or all of the control surfaces thereof to measure a force, moment, or deflection along any corresponding direction. The following discussion elaborates on the dynamics of the present craft, its controls system and method, with particular emphasis on the hydrofoil and a model-based control system and method for achieving useful flight therefrom.

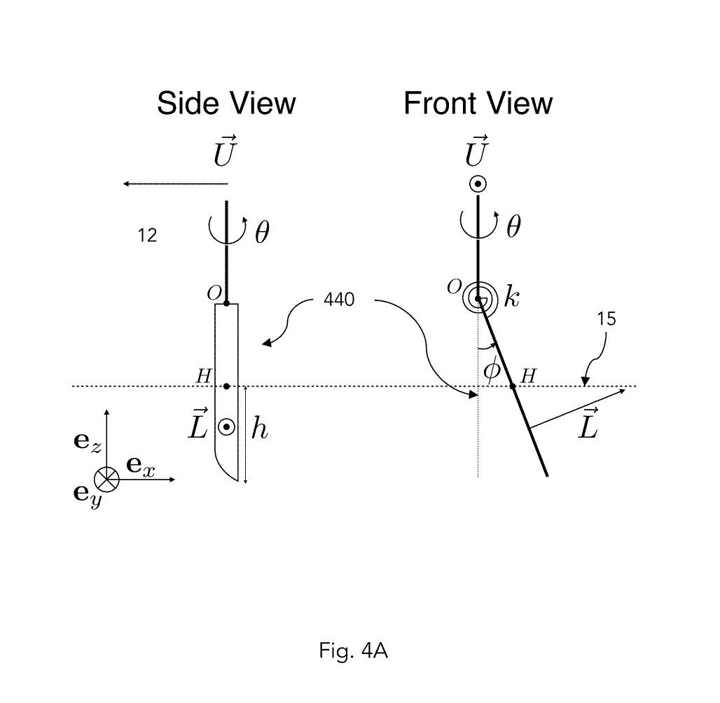

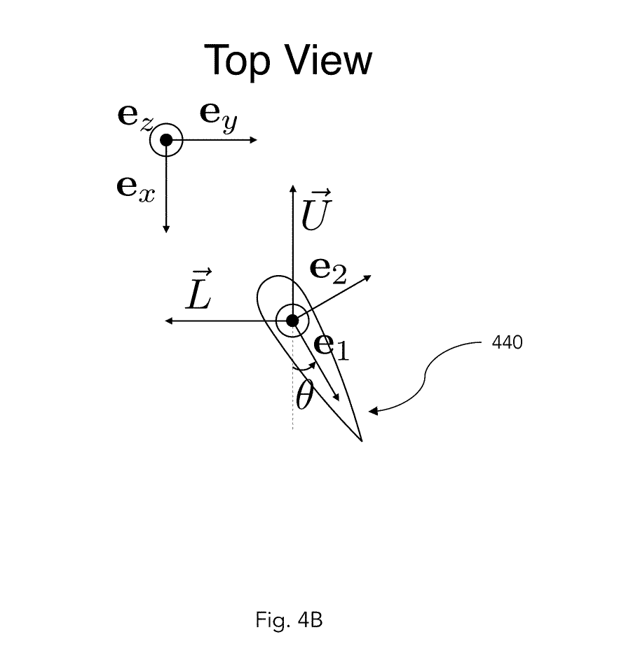

We consider the surface-piercing hydrofoil of FIG. 4, whose base is traveling through water of density p in the forward direction 12 or (−eₓ) at speed U (without waves, the flow would be coming at the vehicle at +Ueₓ). The small-angle foil pitch is θ. Its beam and reference chord are b, c, respectively. As an example, the foil flexibility lumped into a single degree of freedom ϕ represented by a localized hinge bending at the hydrofoil base, of stiffness k and negligible damping. The foil is immersed at a depth h(t)≤b.

The foil dynamics may be modeled as

J\ddot{ϕ}=M_{hinge}+M_{hydro}

where J is the moment inertia and the terms on the right-hand side are the moment due to the hinge stiffness, for instance M_{hinge}=−kϕ, and the moment applied at the hinge point due to hydrodynamic forces respectively. The hydrodynamic forces may include added mass, lift and drag forces, as well as surface effect forces such as wave-making and spray. Those skilled in the art will understand that the present models are but examples facilitating the understanding of the operation of the system and method. Other models, including optional physical conditions and factors can be added or removed from the present illustrative models as needed.

The hydrodynamic forces may depend on the hydrofoil geometry, the hydrofoil pitch, craft yaw, ϕ, the hydrofoil's water-relative position (including the hydrofoil depth immersion h) and orientation, the local water velocity and its derivatives (due to for instance waves or currents), and time-derivatives up to any order of those quantities. For instance, by way of example, in still water with no yaw, the moment due to hydrodynamic forces on the non-ventilating, non-cavitating foil may be modeled with the form

$${M}_{hydro} = q {ch}^{2} {C}_{M , θ} θ + \frac{q {ch}^{3}}{U} {C}_{M , \dot{φ}} \dot{φ} - {m}_{22} \ddot{φ}$$

where C_{M,θ} and C_{M,\dot{ϕ}} and m₂₂ are coefficients that may depend on the foil geometry, h and other parameters for instance the Froude number, and may be computed with various degrees of precision.

Collecting the above terms, within the example model, the hydrofoil dynamics is

a_{\ddot{ϕ}}\ddot{ϕ}+a_{\dot{ϕ}}\dot{ϕ}+a_{ϕ}ϕ=b_{θ}θ

with the time-varying coefficients

$${a}_{\ddot{φ}} = J + {m}_{22} , {a}_{\dot{φ}} = \frac{q {ch}^{3}}{U} {C}_{M , \dot{φ}} , {a}_{φ} = k {b}_{φ} = q {ch}^{2} {C}_{M , θ} , q = \frac{1}{2} ρ {U}^{2} ,$$

Regarding lift forces and moments, and the non-dimensional and non-constant aerodynamic coefficients C_{M,\dot{ϕ}} and C_{M,θ}, they may be computed in the following way. Considering only the immersed part or the hydrofoil, and H the point of the foil that is at the water surface at time t, the local angle of attack at that point is α_{H}=θ+(\dot{ϕ}(b−h)+u_{y})/U. The force and moment at point H on the hydrofoil due to hydrodynamic lift are

L=qch(C_{L,α}α_{H}+C_{L,p},\dot{ϕ}h/(2U))

M_{H}=qch²(C_{l,α}α_{H}+C_{l,p},\dot{ϕ}h/(2U))

where C_{L,α} and C_{L,p} are the force coefficients due to angle of attack and roll rate, respectively, and C_{l,α} and C_{l,p}, are the moment coefficients due to angle of attack and roll rate, respectively. In general, those coefficients are non-trivial, due to surface wave-making effects they are dependent on the Froude number Fᵣ=U/\sqrt{gc}. In practice, for Fᵣ [symbol] 0.1 or Fᵣ [symbol] 1, the dependence is weak, and the coefficients are mostly sensitive to the immersed aspect ratio AR=h/c. For large Froude numbers, the flow may be approximated with the method of images where the horizontal surface plane is a plane of anti-symmetry for the flow. As such, the coefficients can be computed with a panel method such as AVL. In the limit of large aspect ratios, the coefficients tend to 2π, π and 4π/3. In the present model, the hydrodynamic coefficients may be computed and fitted with a third order polynomial, but any other suitable or practical modeling of these coefficients can be similarly or equivalently substituted. Also, the moment due to lift at the hinge is M_{L}=(b−h)L+M_{H}, which can be rewritten as

$${M}_{L} = q {ch}^{2} {C}_{M , θ} ( θ + {u}_{y} \text{/} U ) + \frac{q {ch}^{3}}{U} {C}_{M , \dot{φ}} \dot{φ}$$

$$with$$

$${C}_{M , θ} = ℏ {C}_{L , α} + {C}_{l , α}$$

$${C}_{M , \dot{φ}} = {ℏ}^{2} {C}_{L , α} + ℏ {C}_{l , α} + ℏ {C}_{L , p ′} + {C}_{l , p ′}$$

and ℏ=(b/h−1). Following a similar procedure, one skilled in the art may adapt the procedure to compute the coefficients C_{M,\dot{ϕ}} and C_{M,θ}, as small Froude numbers and/or for ventilated or cavitated hydrofoils.

The lift, moment due to lift generated by the hydrofoil, or bending (all computable from the aforementioned equations within the limits of the example model by one skilled in the art), may be controlled with a tracking Linear Time Varying (LTV) controller. For instance, it was determined experimentally that measurement/estimation of U and h in order to compute in real time the estimates â_{\dot{ϕ}}, â_{ϕ}, \hat{b}_{θ} of a_{\dot{ϕ}}, a_{ϕ}, b_{θ} constituted a model sufficiently accurate to control ϕ with satisfactory performance, i.e., the craft remained stable, tracked approximately a reference value ϕᵣ and the hydrofoil didn't break due to too large forces, all despite changes in U and h, with the control law

$$θ = \frac{1}{{\hat{b}}_{θ}} ( {\hat{a}}_{\dot{φ}} \dot{φ} + {\hat{a}}_{φ} φ + {\hat{a}}_{\ddot{φ}} ( {\ddot{φ}}_{r} + {k}_{1} ( {\dot{φ}}_{r} - \dot{φ} ) + {k}_{2} ( {φ}_{r} - φ ) + {k}_{3} \int ( {φ}_{r} - φ )$$

where the coefficients k₁ k₂ k₃ can be selected by pole placement by one skilled in the art.

This example of a control strategy based on online measurement of h and U with dedicated sensors to reconstitute the highly time-varying coefficients of the linear model proved experimentally a satisfactory approach.

As to the controls and control objectives in an illustrative aspect, these can include 1) maintaining at all times the loading of the hydrofoil below its strength limit, 2) performing robust command following of a commanded loading kϕₘ(t) despite fast and order-of-magnitude variations of the plant due to variations in U and h, and 3) performing noise rejection while maintaining the error within acceptable limits. For instance, assuming that the roll φ of the craft on which the hydrofoil is to be mounted has a known linear dynamics of the form φ=H(s)k\tilde{ϕ} where k\tilde{ϕ} is the loading error, a bound on the allowed error in the vehicle roll constrains the allowable spectrum of the loading error. One particular exemplary hydrofoil system may be designed for a vehicle whose roll dynamics are dominated by damping such that H(s)=0.03/s with a maximum allowable roll |φ|≤2°. As stated elsewhere, it must be understood that the present examples are illustrative and are not limiting of the scope of the present system, method, or exhaustive as to the possible useful embodiments achievable by the system and method.

The hydrofoil equations for control can be stated in a simplified form. In term a_{\ddot{ϕ}}, the added mass, approximately m₂₂=ρπc²/4, typically dominates the material inertia J by over one order of magnitude. Therefore, a_{\dot{ϕ}}/a_{\ddot{ϕ}}˜U/c. For small-scale, high-speed applications, the ratios may be in the 500's to 1000's rad/s, much faster than, e.g., un-modeled pitch actuator dynamics. Therefore, it is possible to ignore, for control, the terms a_{\ddot{ϕ}}\ddot{ϕ}, such that a good approximation for the hydrofoil system is

a_{\dot{ϕ}}(t)\dot{ϕ}+a_{ϕ}(t)ϕ=b_{θ}(t)θ

which is a first-order linear time-varying (LTV) system. Note that the plant pole a_{ϕ}/a_{\dot{ϕ}} may vary by one order of magnitude and the steady-state gain b_{θ}/a_{ϕ} may vary by two orders of magnitude, as the hydrofoil's immersion h varies between zero and 20 cm in an example, and the velocity U ranges from 4 to 10 m/s.

Exemplary controller model: We use a LTV controller, implemented by Euler integration, e.g., at 512 Hz

$$\hat{h} = \frac{1}{{( {s}^{2} \text{/} {p}_{sonar} + \sqrt{2} s \text{/} {p}_{sonar} + 1 )}^{2}} {h}_{sonar}$$

$$\hat{U} = \frac{1}{s \text{/} {p}_{U} + 1} {U}_{GPS}$$

$${\hat{a}}_{\dot{φ}} , {\hat{a}}_{φ} , {\hat{b}}_{φ} formed from \hat{h} , \hat{U} and Eq . ( 2 )$$

$${φ}_{m} = \frac{1}{{( s \text{/} λ + 1 )}^{2}} {φ}_{r}$$

$$\tilde{φ} = φ - {φ}_{m}$$

$$\dot{I} = \tilde{φ} ( c . f . Fig . 6 )$$

$$θ = \frac{η {\hat{a}}_{φ}}{{\hat{b}}_{θ}} φ + \frac{{\hat{a}}_{\dot{φ}}}{{\hat{b}}_{θ}} ( {\dot{φ}}_{m} - 2 β \tilde{φ} - {β}^{2} I )$$

In the above equations, the estimates for the immersion depth and vehicle velocity ĥ and Û are obtained by filtering sonar and GPS velocity measurements and used to compute the time-varying coefficients. The sonar in an example may be operated at 40 Hz with pₛₒₙₐᵣ=12/second, and the GPS at 10 Hz with p_{U}=1/second. However, of course, this is only an example, and other operational parameters are equally as justified. When the hydrofoil is immersed, the reference loading ϕᵣ is directly read from manual remote controller stick input. In the present model, the error signals are computed and the control law is formed. When the hydrofoil is immersed, η=1 such that if the model is perfectly known, the system reduces to (s+β)²∫\tilde{ϕ}=0. The integral aspect of the controller is important as due to misalignments of the rig, θ is known up to a constant bias. Besides the noise due to wave forcing, those skilled in the art may also model the operation of the actuator servo, which can be approximated as a rate-limited, critically-damped second-order system of poorly known cutoff rate pₛₑᵣᵥₒ in the 20 to 60/second range. In an example, β=10/second provides a reasonable performance/robustness trade-off with a 8 dB gain margin and 50 degree phase margin for a_{ϕ}/a_{\dot{ϕ}}=15/second and pₛₑᵣᵥₒ=40/second).

FIGS. 4A and 4B show side, front and top views of a hydrofoil 440 according to the present system and method (excluding the representation of the rest of the system for clarity), and further showing certain quantities used in the present model by way of illustration.

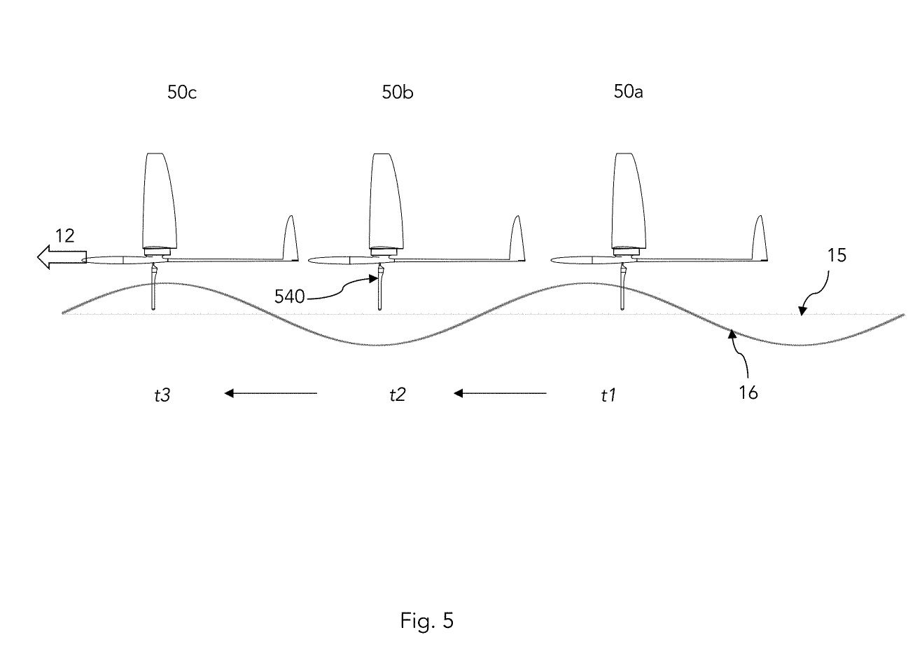

FIG. 5 illustrates one flight scenario of said craft over a disturbed fluid interface. The undisturbed interface (e.g., air-water interface) is denoted as 15, and the actual or disturbed surface is denoted as 16. The craft 50 may travel in a general direction 12 as described before over said interface. Three snapshots of said craft 50 are depicted as 50a, 50b, and 50c, as they may be found at successive times t1, t2, and t3, respectively. It can be seen that hydrofoil 540 dips in and out of the lower fluid (water) as the height of the surface 16 rises and falls, therefore exposing more or less (or none) of the hydrofoil 540 to the forces of the water below. Specifically, a maximum insertion of hydrofoil 540 occurs at wave crests (and/or times) t1 and t3 while least (or no) hydrofoil insertion takes place at t2. The craft 50 continues therefore more or less straight along route 12 with respect to an undisturbed water surface 15, skimming the wave tops as it travels, and having an acceptable and controlled mean state of flight.

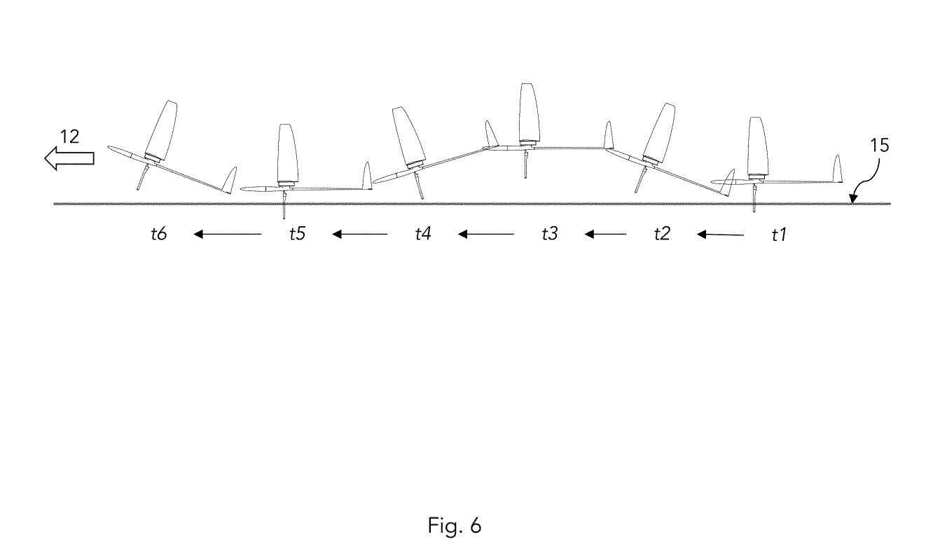

In another flight scenario shown at FIG. 6, craft 60 moves from right to left and is depicted at snapshots in time (t1, t2, . . . , t6). Here, in a hopping flight scenario or mode of operation, the craft 60's trajectory may be a generally cyclic up-and-down trajectory. Craft 60 thus has an elevation height above water from some reference point thereon that increases and decreases in time. At some times (e.g., t1 and t5) the hydrofoil 640 beneath craft 60 is inserted into the water below, while at other times (e.g., t2, t3, t4 and t6) it is only slightly in the water, or not at all. Such a trajectory may be energetically beneficial, if enough hydrofoil lift is generated during phases t1 and t5, while the hydrofoil drag during phases t2-t4 and t6 is reduced compared to phases t1 and t5. Again, though having a different flight path, craft 60 has an acceptable and controlled mean state of flight in a general direction 12. Hybrid and compound flight scenarios are also possible, including over calm or rough water surfaces. For instance, if the system is hopping in a non-flat water surface, it may be beneficial to perform dips at other locations than the wave crests.

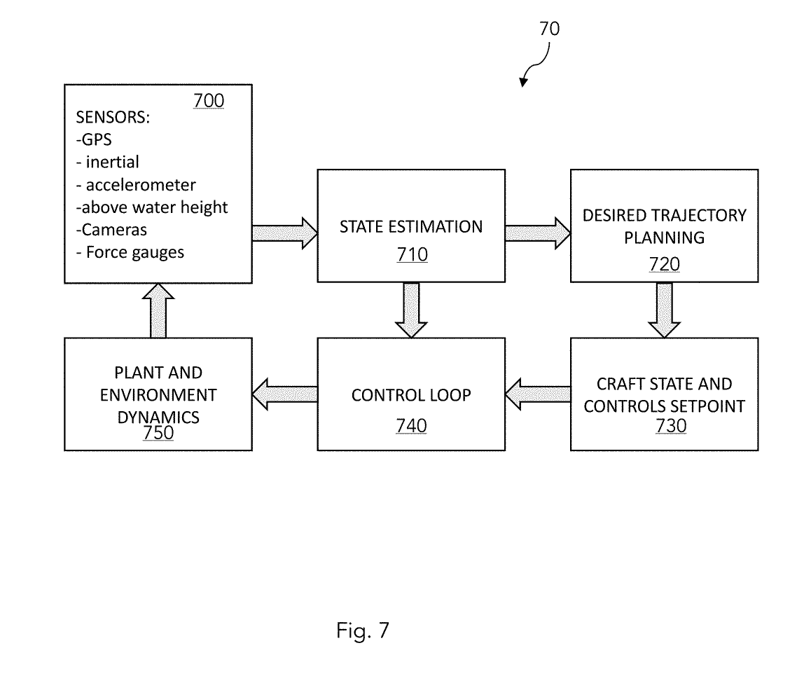

FIG. 7 illustrates a control method 70 for achieving stable flight of a craft as described herein. Generally, the control method includes receiving sensor signals, e.g., GPS/location/speed, sonar height, or other camera sensor signals and/or force gauges at step 700. State estimation (i.e. fusion of sensory information to infer/improve some or all but not reduced to the estimates/belief of: the craft's position, attitude, velocity and angular velocity, hydrodynamic force and/or moment on the hydrofoil, water surface altitude, craft height above water, water velocity, wind field, etc. For instance, in the example control law the water speed is assumed to be 0, h which is directly related to vehicle height above water is computed by fusing GPS, static pressure, accelerometer and sonar information, and the vehicle's speed is estimated by filtering GPS information) is performed at step 710. A high-level, long term desired craft trajectory is generated at step 720 by the trajectory planner (e.g., running at a 1 to 10 sec rate, although this could be slower or faster), for instance based on a preset desired height and flight direction, or the result of an online trajectory generation, for instance the result of an optimization algorithm balancing rewards from mission objective accomplishments, safety requirements in terms of, for instance, minimum height and/or maximum g-force, etc.). The trajectory planning method outputs a desired state and controls command (for instance, desired vehicle attitude and short-term desired position, along with desired lift distribution on the airborne and waterborne lifting surfaces step 730. A control loop process (for instance faster than the planning algorithm, perhaps running at a 50 to 500 Hz rate), such as that exemplified previously for the hydrofoil but which one skilled in the art may design for the aerial control surfaces 740 is carried out in real-time to achieve the desired flight. The physical craft and environment (plant) evolve according to their respective equations of motion 750.

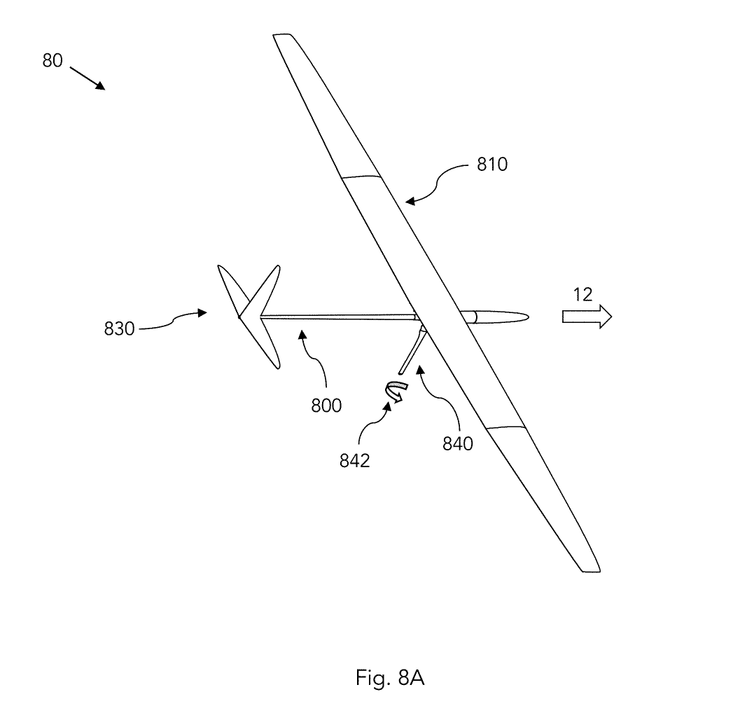

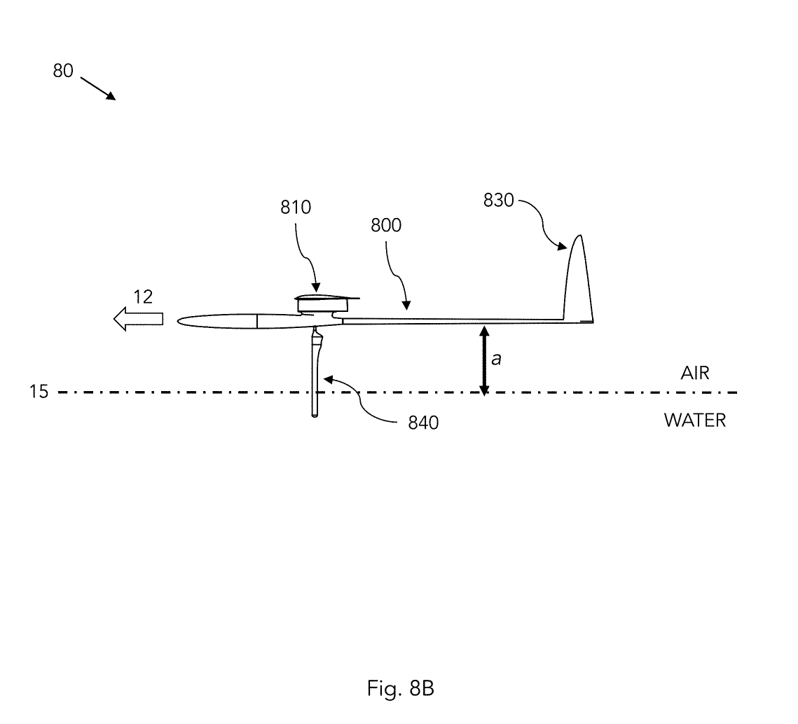

FIG. 8A illustrates a flying craft 80 with a downward-extending hydrofoil 840 which is controllable in real-time to achieve some or all of the above characteristics. In particular, physical sensors such as the described position, speed, flight height, or force sensors (e.g., hydrofoil strain sensors) are used individually or together in any combination to control a rotation 842 of hydrofoil 840 to obtain the needed flight dynamics and lift/drag forces on craft 80. The example of FIG. 8 includes a craft body 800 and a conventional tail 830 and wings 810. However, as explained above, other suitable aerodynamic designs may be employed just as well, including with additional canards, ailerons, and so on. The embodiment of FIG. 8 has been demonstrated by the present inventor to have useful flight dynamics without the use of a vertical aerial sail.

FIG. 8B illustrates a side (port) view of flying craft 80 with water-piercing and real-time controllable hydrofoil 840, which can be flown at a height, a, above an air-water interface 15. As stated herein, the craft 80 may maintain a steady distance from a reference point thereon to the surface of the water 15, or the craft 80 may rise and fall above the surface 15 in a given flight mode of operation, especially where the surface 15 is wavy.

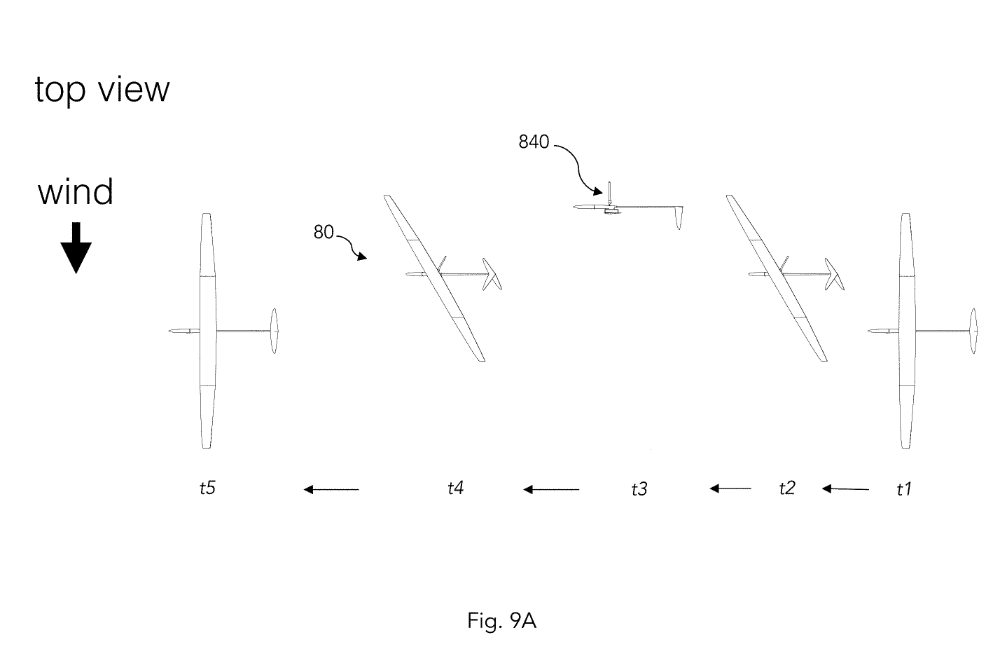

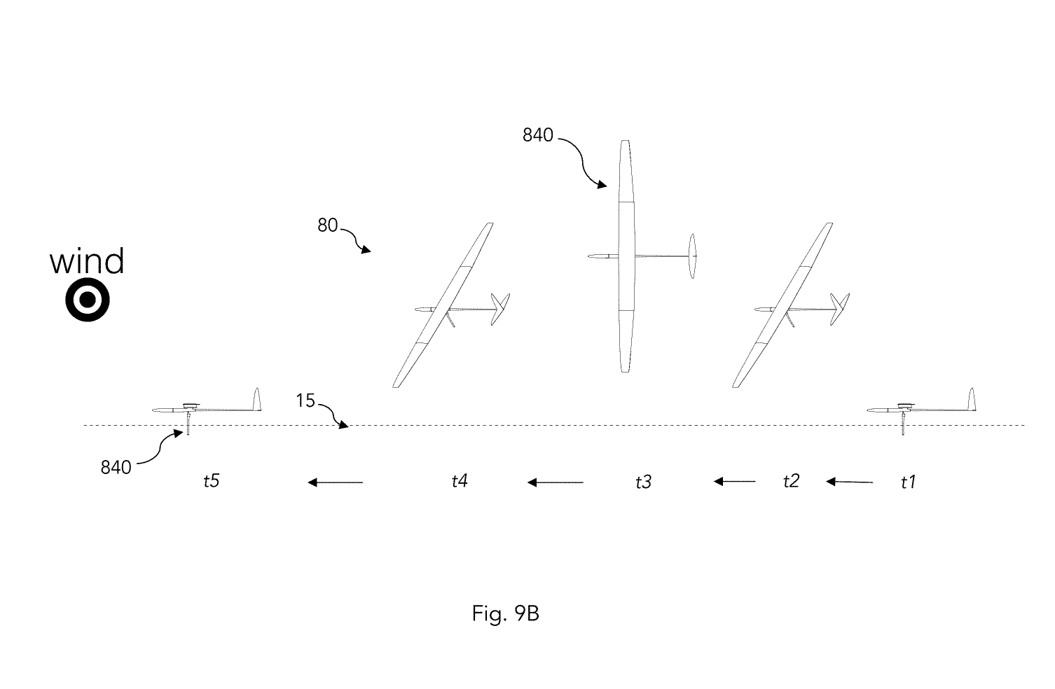

FIG. 9A shows a time lapse illustrating a mode of operation of flying craft 80 over the surface of a body of water according to an embodiment. In this top view, craft 80 travels generally to the left and is shown at successive times t1, t2, . . . , t5 (which is the same configuration as in time t1). Craft 80 has a controlled water-piercing hydrofoil as described before, which dips into the water below and rises from the water at various times during flight. At time t1, the main functions of the craft's lifting surfaces are to counteract gravity with airborne lifting surfaces, and provide upwind force with the hydrofoil; at time t2, the main functions of the craft's lifting surfaces are to counteract gravity, and generate a generally forward and downwind; at optional time t3, the craft's wings 810 are in a generally vertical (flying at a 90-degree roll) configuration such that main function of the craft's lifting surfaces is to generate a generally forward and downwind force; at time t4, the craft is in a similar dynamic as it was at time t2; and at time t5 the craft is in a similar dynamic as it was at time t1.

FIG. 9B shows the time lapse of FIG. 9A from a side (windward) view. We see that controlled hydrofoil 840 pierces the surface of the air-water interface 15 at least at times t1 (and t5) so that craft 80 goes upwards and downwards in elevation above surface 15 while rolling through the phases of its flight. It can be seen that the embodiments described in FIGS. 8A, 8B, 9A and 9B the craft 80 may be flown so that its wings function to provide the lift and drag forces previously associated with wings 110 and sail 120 of FIGS. 1A, 1B and 1C, by timed and controlled rotation of the craft's control surfaces with respect to the plane of the air-water interface (i.e., a direction defined by Earth's gravitational force). Those skilled in the art would appreciate that hybrid modes of operation of such craft can also be achieved, whether such operation is a steady state or cyclic or aperiodic state of operation.

In the foregoing specification, the invention has been described with reference to specific embodiments. However, one of ordinary skill in the art appreciates that various modifications and changes can be made without departing from the scope of the disclosure and embodiments described herein. Accordingly, the specification and figures are to be regarded in an illustrative rather than a restrictive sense, and all such modifications are intended to be included within the scope of this disclosure.

What is claimed is:

1. A vehicle for travel over an air-water interface, comprising:
a vehicle body;
said vehicle including a position-sensing system indicating a position or travel speed of said vehicle;
said vehicle being overall positively buoyant with respect to said water;
a lower portion of said vehicle being configured and arranged for movement through at least said water and an upper portion of said vehicle being configured and arranged for movement through at least said air;
at least one aerial lifting surface, coupled to said vehicle body, and configured and arranged for providing aerodynamic lift;
at least one hydrofoil, coupled to said vehicle body, and configured and arranged for providing a hydrodynamic load;
an elevation-sensor indicating an elevation of a reference point on said hydrofoil with respect to said air-water interface;
at least one force sensor coupled to said hydrofoil and providing a measured output signal indicative of said hydrodynamic load;
the vehicle further comprising a processor receiving inputs representative of: the position or travel speed of the vehicle, the measured output of said force sensor, and the elevation of said reference point;
the processor comprising processing circuitry for processing data and executing machine-readable instructions including control logic, and for providing, responsive to any of said inputs, an output control signal; and
an actuator receiving said output control signal and mechanically controlling at least said hydrofoil responsive to said output control signal.

2. The vehicle of claim 1, said aerial lifting surface comprising a wing disposed in a generally horizontal configuration with respect to said craft body.

3. The vehicle of claim 1, said aerial lifting surface being disposed in a generally vertical configuration with respect to said craft body.

4. The vehicle of claim 1, said hydrofoil providing a hydrodynamic load and being generally downwardly-extending from said craft body disposed in a generally vertical configuration perpendicularly down.

5. The vehicle of claim 1, said actuator comprising an electro-mechanical actuator providing a force on said hydrofoil corresponding to said output control signal.

6. The vehicle of claim 4, said actuator applying a torque to affect a pitching aspect of said hydrofoil.

7. The vehicle of claim 4, said actuator applying a force to affect said elevation of the reference point of said hydrofoil with respect to the air-water interface.

8. The vehicle of claim 1, further comprising a tail section having one or more lifting surfaces thereof.

9. The vehicle of claim 1, said elevation sensor comprising an acoustic transmitter-receiver device ranging a distance separating said sensor and said air-water interface using a time-of-travel of an acoustic signal.

10. The vehicle of claim 1, said actuator comprising at least one direct drive servo acting about at least one corresponding axis.

11. The vehicle of claim 1, said position sensor comprising a global positioning system (GPS).

12. The vehicle of claim 1, further comprising a propulsion system.

13. The vehicle of claim 12, said propulsion system comprising any of an on-board electric motor, on-board fossil fuel burning engine, or a solar panel-driven electric drive system acting as a prime mover to provide forward propulsion to said craft.

14. A method for controlling the travel of a vehicle proximal to an active water surface, comprising:
measuring a location or speed of said vehicle;
measuring an elevation of a reference point on said vehicle above said water surface;
measuring with measured input signals: a hydrodynamic load on a vertical hydrofoil of said vehicle, extending at least partially below said water surface, while said vehicle is traveling;
generating a control output signal based on at least said measured input signals; and
applying a torque on said hydrofoil, about at least one degree of freedom thereof, responsive to the control output signal.

15. The method of claim 14, measuring said speed comprising measuring a relative wind speed.

16. The method of claim 14, measuring said speed comprising measuring a relative water speed of said vehicle.
